(19) United States
(12) Patent Application Publication
(10) Pub. No.: US 2011/0318139 A1
(43) Pub. Date: Dec. 29, 2011

(54) TAPERED NAIL with Stablization Rings

(76) Inventor: Robert Paul Tarleton, Columbia City, IN (US)

(21) Appl. No.: 12/794,276

(22) Filed: Jun. 29, 2010

(51) Int. Cl. F16B 15/00

(52) U.S. Cl. 411/455; 411/439; 411/490

(57) ABSTRACT

A nail is used to fasten wood, plastic, shingles, siding and composite items together. A nail has a head and a shank or shaft. A nail is typically made of a steel or metal alloy but could be made of other materials. The nail is different from conventional nails in that its shank or shaft is not straight or twisted. The shank is tapered. The end near the head of the nail is smaller in diameter then the end that penetrates the material (the point). The shank tapers from the point progressively until it reaches a section near the head that expands to the same diameter as the shank near the point. The shank then tapers again until it reaches the head. The amount of taper varies with the different applications of the nail. The nail's shank also has rounded rings toward the head end of the shank. The rings provide the nail with stability against the host material until the host material rebounds against the tapered shank.

### BACKGROUND OF THE INVENTION

Be it known that I, Robert P. Tarleton, a citizen of the United States, residing in Columbia City, in the county of Whitley and State of Indiana, have invented a new and useful tapered nail, of which the following is a specification.

A nail is used to fasten wood, plastic, shingles, siding and composite items together. A nail is typically made of a steel or metal alloy but could be made of other materials.

In typical applications a nail is used to hold two pieces of material together or a surface material to a subsurface material. The nails success is determined by how well it holds the materials together.

In some circumstances the nail fails to do this over a period of time. In exterior applications, where the materials are exposed to seasonal temperature changes, especially freeze and thaw cycles, failure is possible. When the exterior wood or coverings expand and contract it pulls the standard and spiral nails out. When the climate changes and becomes dry the wood or covering material shrinks. The nail remains in the pulled position and sticks out, up or down.

This means every so often you must pound the nails back in place, until the next cycle moves the nail again.

In any circumstance a nail that has greater holding ability is better. Exterior siding, exterior decks, roofing, drywall and wood all benefit from a nail with better holding ability.

Currently in the exterior wood decking industry many contractors are now using wood deck screws to hold the planking to the joist. The screws are expensive and require a lot of labor or special installation equipment. This increases the cost of the project. Spiral nails hold better than conventional straight shank nails but they can not be used in a pneumatic nail guns and have to be hand driven.

This new nail holds better than a spiral nail and can be used in a pneumatic nail gun. It will cost less in both material and labor.

### SUMMARY OF THE INVENTION

The nail will hold better then conventional nails and spiral nails. The nail is different from conventional nails in that its shank or shaft is not straight or twisted. The shank is tapered. The end near the head of the nail is smaller in diameter then the end that penetrates the material (the point). The shank tapers from the point uniformly until it reaches a section near the head that expands to the same diameter as the shank near the point. The shank then tapers again until it reaches the head. The nails shank also has rounded rings on the shank. The rings provide the nail with stability against the host material until the material rebounds against the tapered shank. The rings supply some resistance against extraction but the rings main propose is stability.

The unique quality is the tapered shank or shaft. It has no sharp edges. The taper allows the material being fastened to be pushed aside as the nail is being driven or pushed into it. After a period of time, especially with wood products, the material being fastened together or penetrated will try to rebound to its original position. A wood product with its natural fibrous construction will always, unless damaged by a sharp edged nail, try to return to its natural state. When it does this it forms around the tapered shank. For the nail to be extracted you are pulling the ever increasing shank diameter through the rebounded host material and an ever decreasing hole. It actually creates more resistance to the extraction as the nail is removed.

The tapered section near the head of the nail, the case of a wood deck, will work independently with the deck boards. The decking material rebounds around this tapered area, when the deck board itself moves, the nail will stay with it. When or if it returns to the original position the nail will also. This taper will help prevent the nail heads from sticking out of the wood as the boards move.

It may be that if the wet or freezing conditions displace the nail only a small amount and the conditions diminish or subside that the tapered nail will return to its original position.

The nail will also be produced differently then a conventional nail. A conventional nail is drawn, cold headed and clipped. The tapered nail will be produced using and thread rolling machine and a special die mold, made to form the nails unique shape when rolled. It is possible that this process has never been used to mass produce nails before.

In testing of prototypes of the tapered nail it took two and sometimes three times more force to remove. The nail was tested for needed extraction force at different times: 1 day, 7 days, 14 days and longer. When tested at 14 days the tapered nail took much more force to extract. On some test nails the amount of force required, actually increased as the nail was extracted. The common and spiral nails always decreased in extraction force required as those nails where extracted.

The increase or small decrease of the force required to extract the nail is due to the design of the tapered shank. The test results where quite amazing.

### BRIEF DESCRIPTION OF THE DRAWINGS

FIG. 1 is a side elevation view of an embodiment of the present invention.

FIG. 2 is a view of the top of the embodiment of the present invention

FIG. 3 is a view of the bottom of the embodiment of the present invention.

### DETAILED DESCRIPTION OF THE PREFERRED EMBODIMENT

The drawing shows a 12d size nail. The dimensions and shapes increase and decrease uniformly as the nail changes in size. (example 8d thru 16d)

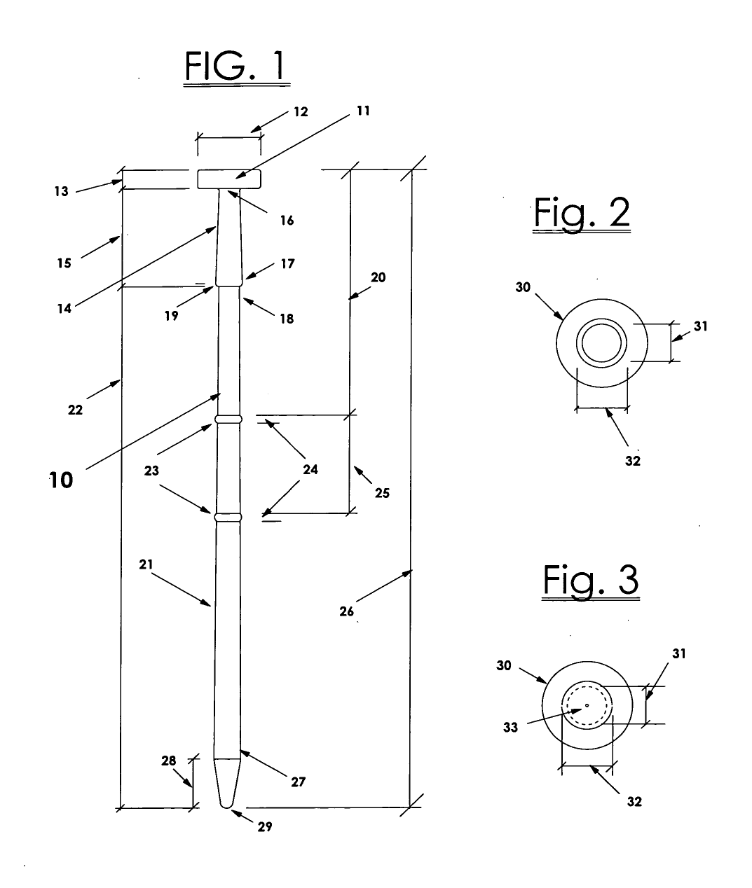

FIG. 1 shows a nail 10 of the present invention. As seen in the Figure, the nail is provided with a head 11, 0.281″ in diameter 12 and 0.096″ thick 13, the upper taper 14 is 0.5″ long 15, the upper tapers narrowest shank 16 is 0.1″, the upper tapers widest shank 17 is 0.131″, the lower tapers narrowest shank 18 is 0.099″ , the transition from the lower to the upper taper 19 has a 0.0155″ radius, the lower taper 21 is 2.655″ long 22, the distance from the top of the nail to the first stabilization ring 20 is 1.25″, the radius and protrusion of the stabilization rings 23 is 0.023″, the width of the stabilization rings 24 is 0.046″, the distance from the center of one stabilization ring to another 25 is 0.5″, the overall length of the nail 26 is 3.25″, the lower tapers largest diameter 27 is 0.131″, the length of the tip 28 is 0.025″, and the tip has a rounded point 29. FIG. 2 shows an embodiment of the top or head end of the nail. The outside of the nail head 30 is 0.3125″, the narrowest diameter of the shank 31 is 0.09″, and the widest diameter of the shank 32 is 0.131″. FIG. 3 shows an embodiment of the nail from tip. The outside of the nail head 30 is 0.3125″, the narrowest part of the shank 31 is 0.09″, the widest part of the shank 32 is 0.131″, and 33 represents the tip of the nail

The shank shape is not restricted by the nail type, length or diameter of the shank or shaft. It can be used to create a common, sinker, roofing, siding, decking or almost any nail type.

While a preferred embodiment of the present invention has been illustrated and described, it will be understood that changes and modifications may be made therein without departing from the invention and its broader aspects.

What is claimed is:

1. A nail for fastening pieces of lumber or other materials together; a nail comprising a head with a substantially flat top, a longitudinal shank attached, centered and perpendicular to the head. The nail displaces material as it is driven or pushed into wood or other substances to hold pieces of material together.

2. The nail as in claim 1, wherein the area of the shank directly beneath the head is a tapered section of specific length and shape. It keeps the surface material attached to the nail.

3. The nail as in claim 1, wherein the area of the shank, which makes up the majority of the shank, is tapered from the tip of the nail to the place where it meets the upper taper. This area of tapered shank provides for the attachment to the host material. When the host material rebounds and conforms to the shank it creates the resistance that gives this nail a hold in the host material that is better then other nails.

4. The nail as in claim 1, wherein the area of the lower taper has two stabilization rings. The rings hold the nail in a solid position, until the host material rebounds against the shank. The rings also supply additional resistance to extraction.
